(19) United States
(12) Patent Application Publication
(10) Pub. No.: US 2009/0011743 A1
(43) Pub. Date: Jan. 8, 2009

(54) MOBILE TRADING CARDS

(75) Inventors: Cynthia Johanson, San Francisco, CA (US); Matthew K. Fukuda, San Francisco, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/772,709

(22) Filed: Jul. 2, 2007

(51) Int. Cl. H04M 3/42

(52) U.S. Cl. 455/414.1

(57) ABSTRACT

A mobile device, system, and method are directed towards enabling users of a mobile device to exchange dynamic mobile trading cards. A first mobile device user may create an account with one or more profiles of sharable static and/or dynamic information. The first mobile device user may employ one of several available mechanisms, to communicate with a sharing service to identify a second mobile device user. The sharing service may then enable the second mobile device user to access and view the shared dynamic profile displayable within a multi-sided mobile trading card format. The shared profile may also be, downloadable into one or more applications onto the second mobile device user's mobile device. Changes to the shared profile by the first mobile device user may be viewed by the second mobile device user without the first mobile device user having to resend the profile to the second mobile device user.

### TECHNICAL FIELD

The present invention relates generally to mobile communications and, more particularly, but not exclusively to enabling a mobile device user to share dynamic profile information in the form of trading cards, based in one embodiment during a face to face communications.

### BACKGROUND

Tremendous changes have been occurring in the Internet that influence our everyday lives. For example, online social networks have become the new meeting grounds. They have been called the new power lunch tables and new golf courses for business life in the U.S. Moreover, many people are using such online social networks to reconnect themselves to their friends, their neighborhood, their community, and the world.

The development of such online social networks touch countless aspects of our everyday lives, providing instant access to people of similar mindsets, and enabling us to form partnerships with more people in more ways than ever before.

One aspect of our everyday lives that may benefit from online social networking technology is sharing of information for people on the go. Sharing of information has become prevalent on mobile devices and has changed our everyday lives. This may be particularly true where people might meet each other in a party, nightclub, business setting, or the like. At such moments, it may be desirable to trade information about each other. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a server device that may be included in a system implementing the invention;

FIG. 4 illustrates a logical flow diagram generally showing one embodiment of a process for sharing of profile information within a social network;

FIG. 5 shows one embodiment of an account record having multiple profiles; and

FIG. 6 shows one embodiment of screen shots of a trading card having multiple sides, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

As used herein, the terms “social network” and “social community” refer to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship, and so forth.

Moreover, the term “social networking information,” refers to both dynamic as well as less dynamic characteristics of a social network. Social networking information includes various profile information about a member, including, but not limited to the member's avatar, contact information, the member's preferences, age, gender, degrees of separation between the member and another member, a membership in an activity, group, or the like. For example, social networking information may also include information about a member's contacts, the member's music preferences, or the like. Moreover, social networking information may also include information about a member's network communication's plan, including whether the member has an unlimited data transfer plan, text plan, or the like.

Social networking information further may include various information about a communications between the member and other members in the social network, including, but not limited to emails, SMS messages, IM messages, Multimedia Message (MMS) messages, alerts, audio messages, phone calls, either received or sent by the member, or the like.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the present invention is directed towards enabling users of a mobile device to readily exchange dynamic mobile trading cards. The trading cards may include information that may be dynamically updated, such as a calendar appointment, or the like. In one embodiment, a first mobile device user may create an account that may include one or more profiles. A profile may include various user information, including relatively static information, such as a name, home address, phone number, or the like, as well as more dynamic information such as photographs, lists of songs, meeting invites, or the like. Virtually any information may be provided within a profile. Thus, shared profiles may be employed for dating events, work events, family events, friends' events, or similar face to face type of events.

When the first mobile device user selects to share a profile with a second mobile device user, the first mobile device employs one of several available mechanisms, described in more detail below, to communicate with a sharing service to identify the second mobile device user. Typically, such sharing may occur during a situation where the parties may be within a relatively close proximity to each other, such as a face to face event, within a same room, or the like.

The sharing service may then modify the profile to include an identifier of the second mobile device user. Such identifier may include an account identifier, a mobile device identifier, a user identifier, or the like. In one embodiment, the sharing service may also modify information associated with the second mobile device, to include, for example, an identifier for the first mobile device. In addition, the sharing service may then enable the second mobile device user to access and view the shared profile. In one embodiment, the shared profile may be displayable within a multi-sided mobile trading card format. The shared profile may also be, in one embodiment, downloadable into one or more applications and/or application formats onto the second mobile device user's mobile device, including into a contact list, address book, message alerts, or the like. When the first mobile device user modifies their shared profile, the second mobile device user will be able to view the updated shared profile, without the first mobile device user contacting and/or resending the shared profile directly to the second mobile device user. Because the user profile may reside with the sharing service, they may be easier to exchange, easier to access, and easier to update dynamically than traditional hard form business cards, or the like. Moreover, loss of a mobile device would not necessarily preclude access to the shared profile information.

In one embodiment, the second mobile device user may be able to receive an alert when something has changed within a shared profile. In addition, the first mobile device user may select to withdraw access to a shared profile by un-associating the second mobile device user's identifier with the shared profile. In one embodiment, the first mobile device user may also enable the second mobile device user to share their profile with yet another mobile device user.

In one embodiment, sharing of a user's profile may be monetized such that the first mobile device user and/or the second mobile device user may receive a reward for having shared a profile. In one embodiment, the reward may include access to coupons, free or reduced fee downloads of music, videos, reduced fees to network access time, or the like.

Moreover, sharing of the profile, in one embodiment, refers to enabling the other device to display the profile information, absent a right to modify such information by the other mobile device user. In one embodiment, however, at least some profile information may be configured, such as through tags, or the like, such that it might not be viewable by anyone other than the author. Thus, for example, in one embodiment, a user might be able to provide personal notes, or the like, about a person represented within a profile. In one embodiment, sharing may include a right, to allow the other device user to further share the profile information with yet another device user; however, such sharing may still be configured to inhibit other users from modifying the profile information.

Although the invention describes sharing of profile information between mobile devices, the invention is not so limited. Thus, for example, the profile information may also be shared between a mobile device and a non-mobile device, or even between two non-mobile client devices, or any other combination of client devices, without departing from the scope of the invention.

### Illustrative Operating Environment

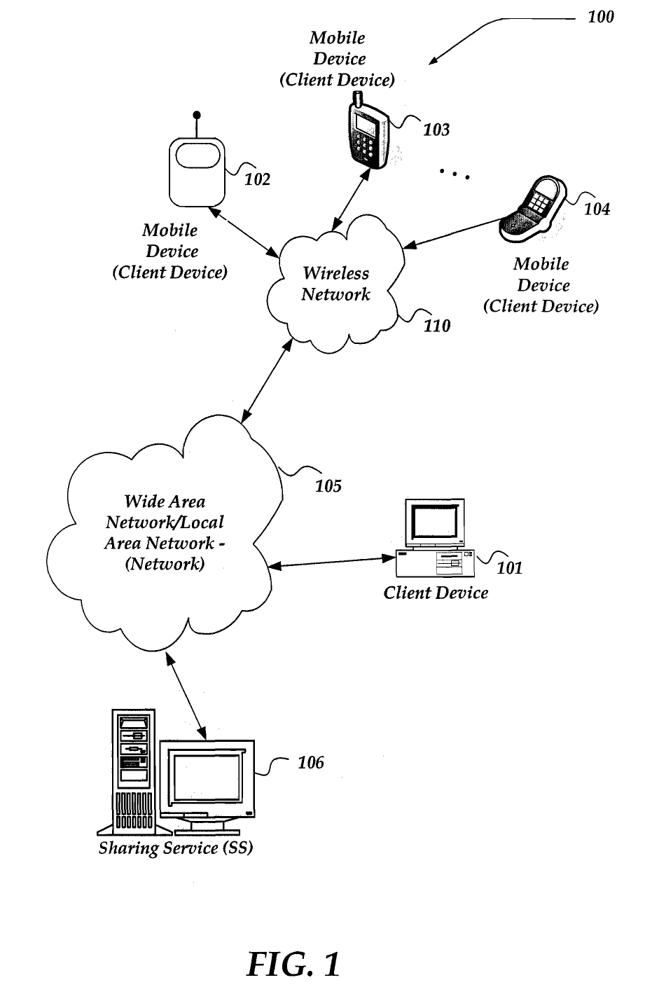

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs'”)/wide area networks (“WANs”)−(network) 105, wireless network 110, Sharing Service (SS) 106, mobile devices (client devices) 102-104, and client device 101.

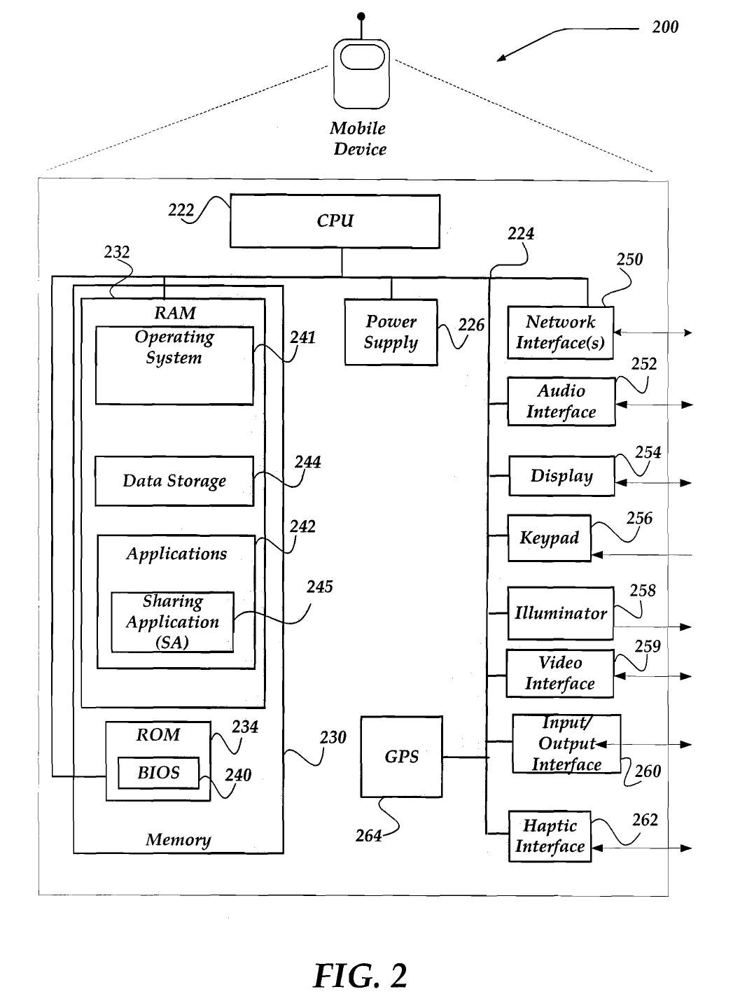

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send a message.

Mobile devices 102-104 also may include at least one other client application that is configured to receive content from another computing device. The client application may include a capability to provide and receive textual content, multimedia information, or the like. The client application may further provide information that identifies itself, including a type, capability, name, or the like. In one embodiment, mobile devices 102-104 may uniquely identify themselves through any of a variety of mechanisms, including a phone number, Mobile Identification Number (MIN), an electronic serial number (ESN), network address, or other device identifier. The information may also indicate a content format that the mobile device is enabled to employ. Such information may be provided in a message, or the like, sent to SS 106, client device 101, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, or the like, between another computing device, such as SS 106, client device 101, or the like. However, the present invention is not limited to these message protocols, and virtually any other message protocol may be employed.

Mobile devices 102-104 may further be configured to include a client application that enables the end-user to log into an end-user account that may be managed by another computing device, such as SS 106. Such end-user account, for example, may be configured to enable the end-user to receive emails, send/receive IM messages, SMS messages, access selected web pages, participate in a social networking activity, share a mobile device user's profile, or the like. However, sharing of mobile device user's profiles may also be performed without logging into the end-user account.

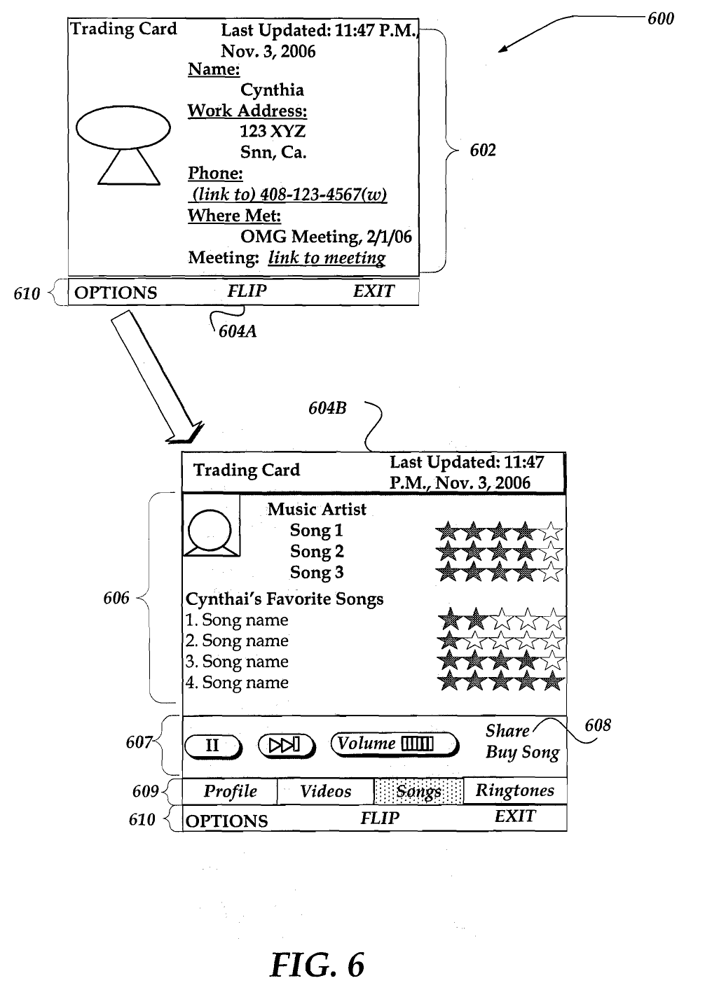

In addition, mobile devices 102-104 may include another application that is configured to enable the mobile user to share, view, and/or receive for display a trading card useable in sharing and accessing various user profile information. In one embodiment, the application may be downloaded onto a mobile device, for example, over networks 105 and 110 from SS 106, or the like. In another embodiment, mobile devices 102-104 may employ a browser interface to access a website, applet, script, or the like that enables sharing of profile information. In one embodiment, the profile information may be shared through trading cards. In one embodiment, the trading cards may be multi-sided to enable partitioning of profile information based on a category. One embodiment of a multi-sided trading card is described in more detail below in conjunction with FIG. 6.

However, the invention is not so limited, and virtually any format may be employed to display profile information. For example, the profile information may be displayed within an address book format, a calendar format, an alert format, or the like. Moreover, the profile information may include links to other information, including but not limited to photographs, music, videos, or the like. In any event, mobile devices 102-104 may enable a user to communicate with SS 106 to establish an account and to create profiles to be shared with one more other client devices 101-104, such as described in more detail below.

Mobile devices 102-104 may also communicate with non-mobile client devices, such as client device 101, or the like. In one embodiment, such communications may include participation in social networking activities, including sharing of profile information, or the like.

Client device 101 may include virtually any computing device capable of communicating over a network to send and receive information, including trading cards, and/or other profile information, or the like. The set of such devices may include devices that typically connect using a wired communications medium such as personal computers, multiprocessor systems, microprocessor-based or programmable consumer electronics, network PCs, or the like. Similarly, client device 101 may include one or more applications as described above in conjunction with mobile devices 102-104.

Wireless network 110 is configured to couple mobile devices 102-104 and its components with network 105. Wireless network 110 may include any of a variety of wireless sub-networks that may further overlay stand-alone ad-hoc networks, or the like, to provide an infrastructure-oriented connection for mobile devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between mobile device s 102-104 and another computing device, network, or the like.

Network 105 is configured to couple SS 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between SS 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

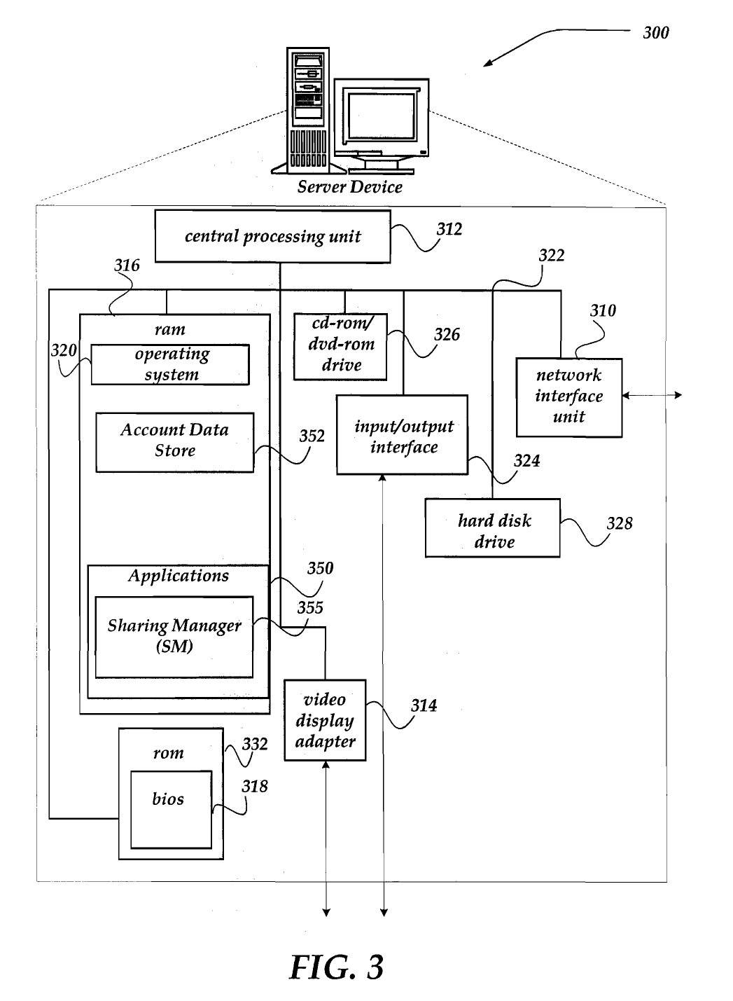

One embodiment of SS 106 is described in more detail below in conjunction with FIG. 3. Briefly, however, SS 106 may include any computing device capable of connecting to network 105 to enable sharing of profile information using, for example, trading cards. However, as noted above, profile information may also be shared using any of a variety of other formats, or the like.

SS 106 may be configured to create and manage accounts for a user for use in sharing profile information. In one embodiment, SS 106 may employ a phone number, or other device identifier to associate an account to a mobile device. SS 106 may automatically create an account for a mobile device, based on a request to share profile information by a mobile device user. For example, in one embodiment one of mobile devices 102-104 may send a request to SS 106 to establish an account, create a profile, or the like. In one embodiment, during a communication with the mobile device, SS 106 may request and/or receive a device identifier.

In one embodiment, the account may already exist, such as an account associated with a user's email account, Internet Service Provider (ISP) account, or the like. In one embodiment, an account may include at least some information about a user, including, for example, a phone number or other device identifier. In one embodiment, SS 106 may receive additional information from the user, including, but not limited to name, email address, other phone numbers, a street address, or the like. At least some of this information may be associated with a general profile. The user of the mobile device may further define one or more other profiles. Thus, for example, the user may create one profile for family and/or other profiles for co-workers, dating relationships, party friends, church friends, or the like. In one embodiment, SS 106 may provide a default identifier to profile; however, in another embodiment, the user may provide a name to a profile.

The created profile may include any of a variety of information. For example, the profile may include information that may be considered to be relatively static, in that it may not change often. Such information may include, but is not limited to, name, email address, home address, phone number, work address, or the like. The profile may also include information that may be more dynamic in nature, such as age information, photographs, music likes, or the like. In one embodiment, the user may partition the profile information into various categories, such as personal information, calendaring information, videos, music, ringtones the user likes, or the like. In one embodiment, various links may be employed to enable access to some of the profile information. For example, the user may include a link, such as an HTTP link, or the like, to music, ringtones, videos, photographs, calendar information, alerts, invites, or the like. In one embodiment, profiles may be displayed at a mobile device in the form of trading cards. In one embodiment, the trading cards may have a plurality of sides, where each side may be configured to display different profile information, such as videos on one side, general user information on another, or music information on yet another side. One embodiment of a trading card useable for displaying profile information is described in more detail below in conjunction with FIG. 6. In one embodiment, the profile information may be integrated with the local device to display dynamic information through the phone's address book and to handle phone actions such as initiating a phone number, an SMS, or the like.

It should be noted, however, that the invention is not constrained to using trading cards as described herein for sharing profile information. Thus, profile information may also be shared using other formats, including traditional address book formats, calendar formats, business card formats, or the like, without departing from the scope of the invention.

SS 106 enables a user to readily update their profiles, including changing information that may be shared, deleting information, or even changing who may be able to access a profile. For example, a profile owner may dynamically change a profile to include invites, meeting information, changes in phone numbers, addresses, personal favorites such as music, or the like. Thus, SS 106 enables profiles to dynamically change, unlike traditional business cards, or the like.

In one embodiment, SS 106 may provide an alert to users with which a profile is shared, indicating that the profile has changed. In one embodiment, SS 106 may display changed information within a profile using a different font, color, size, highlighting, bolding, or the like, to indicate that the information has changed. Change information may be identified for a period of time, until viewed, or based on a variety of other criteria.

SS 106 may also provide an application, script, applet, or the like, that may be used by a client device to enable managing and/or sharing of profile information by a user at the client device. In one embodiment, SS 106 may provide the application, script, applet, or the like, as a downloadable component to the client device, such as mobile devices 102-104, client device 101, or the like. In another embodiment, SS 106 may provide a mechanism that enables the client device to view and/or manage profile information using a browser interface.

SS 106 may also be configured to monitor sharing of profile information and provide a reward based on the sharing. For example, SS 106 may provide a reward to the user that shares their profile information with another user. SS 106 may also provide a reward to the other user with which the profile information is shared. In one embodiment, the reward may include a reduction in a cost of a service, however, other rewards may also be provided. Such other examples, include, but are not limited to providing access to downloadable music, videos, ringtones, or the like for free or for a reduced cost. SS 106 may, in one embodiment, enable a user participating in the sharing of profiles, to play music for a period of time, and then remove such reward after the time period is exceeded.

SS 106 may receive a request from a mobile device, such as mobile devices 102-104 to share profile information with another mobile device. Such requests may be received using a variety of mechanisms. For example, in one embodiment, SS 106 may receive an SMS message, IM message, or the like, instructing SS 106 to enable a profile associated with the requesting mobile device to be shared. SS 106 may determine the account with which the profile is associated with, based on a phone number, or other device identifier for the requesting mobile device. SS 106 may, also receive information from the requesting mobile device indicating a phone number or other device identifier with which the profile information is to be shared. SS 106 may also receive a profile identifier indicating which profile is to be shared. In one embodiment, where the requesting mobile device has but one profile, SS 106 may select to enable access to that profile, and not request identification of the profile to be shared.

SS 106 may also enable a user to designate whether a profile may be shared with yet other users. Thus, SSL 106 may allow a first user, for example, to designate whether their profile may be shared by a second user with a third user, fourth user, or so forth. SS 106 may also enable the user that owns the profile to restrict access to the profile based on a specific identifier, phone number, account number, or the like; to limit a number of times a profile may be shared by others, or the like.

Communication with SS 106 may also be performed using a variety of other mechanisms. For example, in one embodiment, two (or more) mobile devices may be placed physically within a sufficient proximity and configured such that they may be able to communicate using a wireless interface protocol, such as Bluetooth™, infrared, Wi-Fi, Zigbee, or the like. Then, in one embodiment, each of the mobile devices may send a communication to SS 106 indicating that profile information is to be shared by at least one of the communicating mobile devices. In one embodiment, information about which devices are communicating with which other devices may also be shared with SS 106. For example, each device in communication with another device might also send to SS 106 the other devices' device identifiers. In one embodiment, the sharing mobile device may provide a message to SS 106 indicating which profile is to be shared. SS 106 may then obtain from the mobile devices their device identifiers and update the sharing mobile device's account profile data store with the obtain device identifiers.

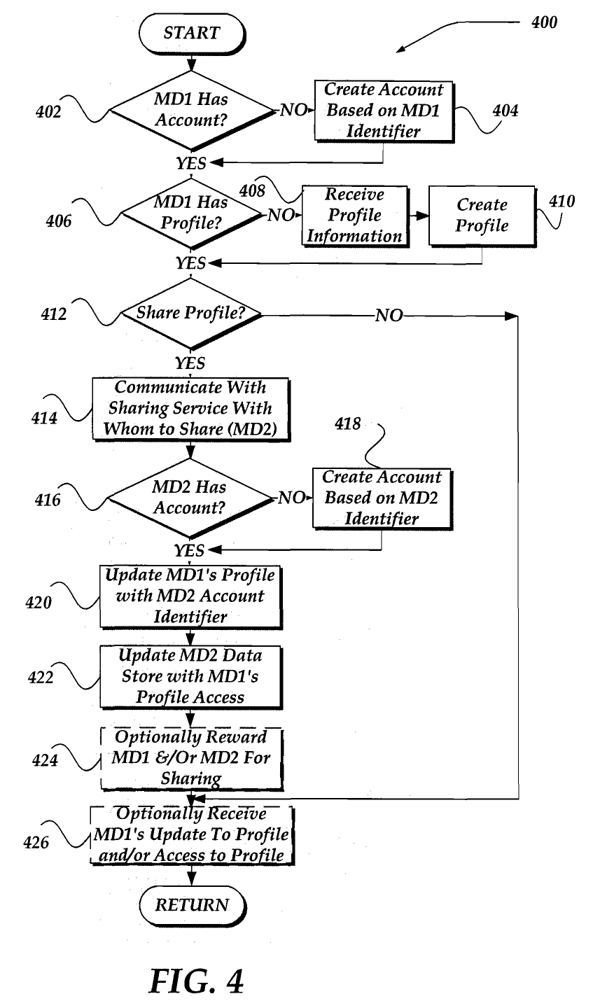

In still another embodiment, mobile devices that are to share profile information may also contact SS 106 and may provide a code to SS 106. If SS 106 receives the same code from the other mobile devices, SS 106 may then update a requesting mobile device's account profile data store with received device identifiers, to permit a profile to be shared. It should be noted, that while the above provides several examples, of how mobile devices may provide indication to SS 106 that a profile is to be shared, the invention is not constrained to these examples. Thus, any of a variety of other mechanisms may be used, without departing from the scope of the invention. Moreover, although described in terms of mobile devices sharing profile information, the invention may also allow a mobile device to share profile information with a non-mobile device, such as client device 101, or the like. SS 106 may employ a process substantially similar to that described below in conjunction with FIG. 4 to perform at least some of its actions.

Devices that may operate as SS 106 include personal computers desktop computers, multiprocessor systems, microprocessor-based or programmable consumer electronics, network PCs, servers, or the like.

Although FIG. 1 illustrates SS 106 as a single computing device, the invention is not so limited. For example, one or more functions of SS 106 may be distributed across one or more distinct computing devices. For example, managing various account activities, including sharing of profile information, rewarding of user, or the like, may be performed by a plurality of computing devices, without departing from the scope or spirit of the present invention.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, r any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store personal information including but not limited to address lists, contact lists, personal preferences, or the like. Data storage 244 may also include some profile information. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may also include sharing application (SA) 245. In one embodiment, SA 245 may be a browser application. However, in another embodiment, SA 245 may be an applet, script, or the like, that is configured and arranged to enable sharing and/or managing of profile information. SA 245 may also be configured to interact with other applications to provide enhanced functionality to one or more other applications for sharing/managing of profile information. In one embodiment, SA 245 may also be an application downloaded over a network onto mobile device 200.

SA 245 may be configured to enable a user of mobile device 200 to communicate over a network, such as networks 110 and/or 105 of FIG. 1, to establish an account based, in part, on a device identifier, or the like. SA 245 may then enable the user to provide profile information such as static, and/or dynamic information, including hyperlinks, or the like, to information for sharing. SA 245 may then enable the user to establish a relationship with another device, such as through Bluetooth™, IM, SMS, or the like. In one embodiment, a communication with the other device with which profile information is to be shared, is not required. Thus, for example, multiple users may provide a code to a sharing service that may be used to identify which devices are to share profile information with which devices. However, as described above, mobile device 200 may employ SA 245, at least in part, to communicate with another mobile device, and also with the sharing service. The sharing service may then receive a device identifier from the communicating mobile devices, and enable profile sharing.

SA 245 may also enable access and display of a shared profile. In one embodiment, SA 245 may access the shared profile from the sharing service over a network. However, in one embodiment, SA 245 may also be configured to download the shared profile onto mobile device 200, and either display the profile within SA 245, and/or enable another application, such as a calendar, email client, or the like, to access and display the profile information.

SA 245 may further enable a user to modify the contents of their profile information, including deleting access to at least some of their profile information by another user, enabling other users to share their profile with yet other users, or the like. In one embodiment, SA 245 may indicate that an alert might be sent to other devices for which the profile is shared, when the profile is changed.

### Illustrative Server Environment

FIG. 3 shows one embodiment of a network device, according to one embodiment of the invention. Server device 300 may include many more components than those shown. The components shown, however, are sufficient to disclose an illustrative embodiment for practicing the invention. Server device 300 may represent, for example, SS 106 of FIG. 1.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of server device 300. Any general-purpose operating system may be employed. Basic input/output system (“BIOS”) 318 is also provided for controlling the low-level operation of server device 300. As illustrated in FIG. 3, server device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, web servers, IM message servers, email servers, account management and so forth. Applications 350 may include Sharing Manager (SM) 355.

SM 355 may be configured and arranged to enable sharing of profile information between client devices, such as mobile devices 102-104 of FIG. 1, or the like. SM 355 may provide an interface to the mobile devices that enable a user to generate an account, create one or more profiles, and manage information to be shared within the one or more profiles.

SM 355 may automatically generate an account based on receiving a request to generate a profile, share a profile or the like, from a client device. In one embodiment, SM 355 may receive a device identifier, such as a phone number, or the like, from the client device. SM 355 may then employ the device identifier to create the account and associate the device identifier with the account. In one embodiment, SM 355 may employ account data store 352 to store device identifier, account, and profile information.

SM 355 may then provide an interface that enables a user to identify another device with which one or more of the profiles are to be shared. SM 355 may employ any of a variety of mechanisms, including those described above, to obtain the identity of the other devices with which the profile is to be shared. In one embodiment, for example, the devices may both communicate with SM 355 and provide a shared code to identify that the profile is to be shared. In another example, the device associated with the profile to be shared may send a phone number of the other device to which the profile is to be shared. SM 355 is not limited to these examples, and other mechanisms may also be used.

In any event, SM 355 may update the stored profile information with the device identifier for which the information is to be shared. In one embodiment, SM 355 may also send an alert to the other device indicating that the profile is available to be viewed. SM 355 may also send an IM message, an SMS message, email message, or the like. In one embodiment, where the other device does not currently have an account associated with it, SM 355 may automatically create an account, associate its device identifier with the new account, and store such information into account data store 352. In one embodiment, SM 355 may create a default profile for the new account. In one embodiment, the new account may also include information about which devices have shared profiles with the other device.

SM 355 may further receive changes to the profile information from a profile owner, including deletions, and/or additions of access rights to the profile information by another device. SM 355 may provide a message, alert, or the like, to any affected other devices indicating that a profile that they may have had access has changed. In one embodiment, changes may be identified using a variety of mechanisms, including blinking, bolding, underlining, highlighting, color changes, or the like. SM 355 further enables an account owner to delete an account.

SM 355 may enable the shared profile to be viewed using a variety of formats, including multi-sided trading cards, such as described below in conjunction with FIG. 6. However, the format for display is not restricted to trading cards. For example, an email format, a business card format, an address book format, or the like, may also be used to display shared profile information. SM 335 may further employ a process such as described below in conjunction with FIG. 4 to perform at least some of its actions.

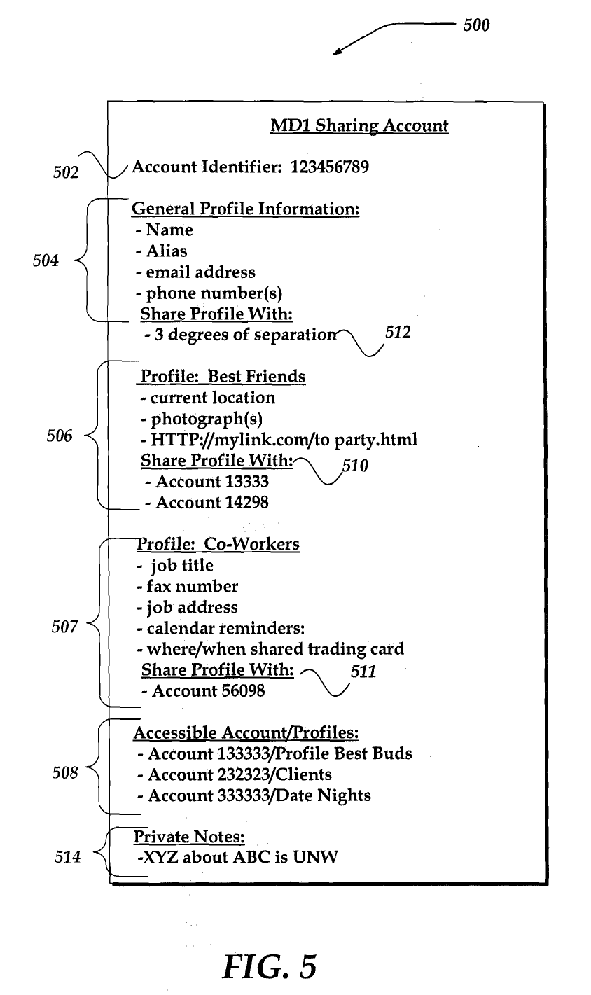

Account data store 352 is configured and arranged to store a plurality of accounts having zero or more profiles. Account data store 352 may store the account and/or profile information into a category structure, such as folders, albums, graphs, trees, database, or the like. One example embodiment of a format useable for storing account information is illustrated in FIG. 5.

As shown in FIG. 5, account record 500 may include an account identifier 502, general profile information 504, one or more profiles 506-507, accessible account/profile identifiers 508, and private notes 514. Account record 500 may include many more or less components than those shown. The components shown, however, are sufficient to disclose an illustrative embodiment for practicing the invention. Account record 500 may be accessible within account data store 352 based on a device identifier, such as a phone number or the like.

As shown, general profile information 504 may include one or more items that a user associated with the account identifier 502 may want to share across all profiles. Such information may be an empty set, or include any of a variety of items, including, such as a name, alias, email address, phone number, or the like. The user may further provide information for a profile such as profile 506 that might be shared to another device. Thus, as shown, profile 506 may enable sharing of such information as a current location of the account owner's mobile device, as well as photographs, or other images, and a link to an invite, or the like. Virtually any information may be included, and those shown are merely examples, and not intended to limit the invention in any manner. Thus, profile 507 illustrates a different set of possible information that may be shared. Moreover, as shown, profiles 506-507 include a list of zero or more accounts with which the profiles are to be shared (share profile 510 and 511).

Also shown in the figure, the account owner may be able to designate whether a profile may be shared by other users. For example, as illustrated, sharable 512 indicates that the account owner has enabled general profile information 504 to be sharable by others at a three-degree of separation level of sharing. That is, the account owner may enable sharing of a profile with a second user, and that second user may also share the account owner's profile with a third user, not having current direct relationship with the account owner. However, the third user would be restricted from sharing the account owner's profile with yet a fourth user. However, sharable 512 is not limited to designating degree of separation limitations, and others may be employed. For example, sharable 512 may enable the account owner to designate exclusions, where the profile may not be shared; a number of times that the profile may be shared by another user, before the other user is unable to continue to share the profile, or the like. Moreover, sharable 512 may be included within any of profiles 506-507, as well.

In addition, account record 500 may include private notes 514, which represents one embodiment of profile information that might be configured and arranged to be non-viewable by another user. Although such information is illustrated within a distinct category, the invention is not so constrained. Thus, for example, private notes 514 may also be included as a subset within another profile, such as profiles 504, or 506-508, without departing from the scope of the invention.

In one embodiment, account record 500 may also include accessible accounts 508 that include a listing of account/profiles for which the owner of account record 500 may be allowed to access.

Although, account record 500 is illustrated as a flat record structure, the invention is not so limited. For example, within a profile, the owner may partition subsets of information into categories that may then be displayable within an n-sided trading card, such as described below. Therefore, account record 500 may include links, or additional sub-records configure to enable the owner to manage such partitioned information. Other variations of account record 500 may also be employed, and thus, FIG. 5 is not intended to be limiting, but rather merely to provide one possible example of how profile information might be managed.

Moreover, in one embodiment, account record 500 may be maintained on server device 300, such when information within a profile is updated, others may be able to access and view the changed profile. In this manner, the profile may be dynamic, enabling easy viewing, exchanges, and updates across a plurality of other devices.

### Generalized Operation

The operation of certain aspects of the invention will now be described with respect to FIG. 4. FIG. 4 illustrates a logical flow diagram generally showing one embodiment of a process for sharing of multimedia information within a social network. Process 400 of FIG. 4 may be implemented with SS 106 of FIG. 1, for example.

As shown, process 400 begins, after a start block, at decision block 402 where a mobile device (MD1) has indicated that profile information is to be shared with another device (MD2). Although the process describes sharing with a single other device, MD2, the invention is not so constrained. For example, sharing may be performed with a plurality of other device simultaneously, without departing from the scope of the invention. However, for simplicity, the process is described as sharing with a single mobile device, MD2.

Thus, at decision block 402, a determination is made whether MD1 has associated with it an existing account. Such determination may be made, for example, based on receiving a device identifier from MD1, such as a phone number, or the like, and performing a lookup into a data store for an account associated with the device identifier. If an account is not located, processing may flow to block 404, where an account may automatically be created and associated with the device identifier. Processing would then loop back to decision block 406. If an account is located, processing proceeds to decision block 406.

At decision block 406, a determination is made whether MD1 has a profile to be shared. If not, processing proceeds to block 408, where information may be received to populate a profile. Such information may be received from the MD1 owner, from another account, or even determined as default data. For example, in one embodiment, a default profile may be created at block 410 that includes a device identifier for MD1. In any event, the user of MD1 may provide any of a variety of information with which to include within a profile. Processing then flows to block 410, where the received information may be used to create a profile within the account. Although process 400 may imply that a single process is created, it should be recognized that the MD1 owner may create a plurality of profiles. In one embodiment, the MD1 owner may further select to provide an identifier to each profile. However, in another embodiment, each profile may be automatically identified, such as with a character, a number, or the like. Processing then flows to decision block 412.

At decision block 412, a determination is made whether MD1 has indicated a profile is to be shared. If so, processing flows to block 414; otherwise, processing branches to block 426. Such determination may be based on a variety of criteria, including, but not limited to receiving an instruction from the MD1, or the like. It should be noted, that while MD1 may enable sharing of its profile information with another device, MD1 does not necessarily also allow a user of the other device to modify that profile information. Thus, sharing of the profile information, in one embodiment, refers to enabling the other device to display the profile information, absent a right to modify such information. In one embodiment, sharing may also include a right, however, to allow the other device user to further share the profile information with yet another device user; however, such sharing may still be configured to inhibit other users from modifying the profile information. Moreover, at least some of the profile information may be configured such that it might not be viewable by another device user, such as described elsewhere.

At block 414, any of a variety of communication mechanisms, such as described above, may be used to identify the other device(s) with which a profile is to be shared. Typically, such sharing is performed where the mobile devices are within a close proximity, such as might be employed to enable a personal area network (PAN) communications, wireless PAN (WPAN), Bluetooth™, Ultra-wide band communication (UWB), Infrared Data Association (IrDA) interfaces, or the like. However, the invention is not so constrained. For example, in one embodiment, the users of the mobile devices may be in communication with each other over a voice telephone (PSTN), or the like, and communicate information between each other that may enable the sharing. Thus, in one embodiment, MD1 may provide an identifier for MD2 with which a profile is to be shared. In another embodiment, multiple devices may send a code along with a device identifier within a given time period, indicating that a profile is to be shared among the devices sending the code. In one embodiment, the MD1 may also indicate which profile is to be shared.

Processing then flows to decision block 416, where a determination is made whether MD2 (and/or any other devices with which the profile is to be shared) has an account. If not, then processing may flow to block 418, where an account may be automatically generated based on MD2's (or other devices') device identifier. Processing then flows to block 420. If an account for MD2 (or other devices) already exists, then processing flows to block 420.

At block 420, MD1's profile information may be updated to include an account identifier, device identifier or the like, associated with MD2 (or others). The update is directed to indicate that a particular profile MD2 has rights to access the profile information. In one embodiment, the profile is remotely accessed by MD2, to enable the profile information to be dynamic, and/or easily updated by MD1. In one embodiment, however, MD2 may select to download a profile onto MD2. In that situation, however, MD2 might receive an alert, or other message, when a profile has changed. In one embodiment, the downloaded information might by formatted as dynamic links back to a server stored profile, such that as the information changes, the changes might be reflected into the downloaded profile.

In any event, processing continues next to block 422, where MD2's data store may also be updated to include information about which profiles MD2 has access to. Processing continues to block 424, where, optionally, a reward might be provided to MD1 and/or MD2 for sharing of a profile. Such rewards may include any of a variety of items, services, products, or the like, including, for example, those described above.

Processing continues to block 426, where optionally, MD1 may select to update one or more profiles, including rights to access a profile by another device. In one embodiment, an alert, message, or the like, might be sent to the devices affected by the change. In another embodiment, however, an alert, or the like, might not be sent, and instead, every time a user of a device seeks to access MD1's information, the user's device may poll the sharing service to retrieve the updated information. The invention is not limited to these mechanisms, however, and a variety of other mechanisms may also be used. Thus, for example, a combination of the above might be used. For example, where time criteria information is updated in a profile, such as a meeting notice, or the like, an alert, or the like, might be used, while other information might be updated when the user of the other device seeks to access MD1's profile. Process 400 then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Trading Card

Possible embodiments of trading cards useable in virally sharing of profile information will now be described. It should be noted that the following illustrations are not intended to limit the invention. Instead, they are intended to merely provide an understanding of how the invention may be employed. Thus, FIG. 6 shows one embodiment of a screen shot useable for sharing of profile information using trading cards on a mobile device.

As shown use case 600 may include many more or less components than those shown in FIG. 6. However, the components shown are sufficient to disclose an illustrative embodiment for practicing the present invention.

As shown, screen shot 600, and an expansion of different sides of a trading card. Such different sides of a trading card include first side 604A and second side 604B. It should be noted however, that while screen shot 600 illustrates a multi-sided trading card, the invention is not limited to multi-sided trading cards. Thus, for example, the trading card might include a single side. Moreover, as noted above, the profile information may also be provided within another format besides trading card formats.

When a mobile device user selects to display a trading card, the screen may display, in one embodiment, one side of the selected trading card—here as first side 604A. Clearly, other arrangements may also be displayed. For example, in one embodiment, a rotating trading card might be displayed, wherein the trading card rotates about an axis, and the user may click on a particular side of the card for further examination.

In any event, as illustrated, first side 604A may include, in addition, to an avatar, photograph, or the like, various other profile information 602 including name, address, phone number, or the like. In one embodiment, the profile information 602 might include links to other information, last updated status, or the like. For example, as shown, a phone number may be represented through a link, to enable such information to be integrated with an address book, or the like. Similarly, meeting notices, or other information, may also be represented through links, or the like. In one embodiment, first side 604A may enable the user to view another side of the trading card 604A using one of the commands 610 provided. Selection of another side of the trading card may, in one embodiment, provide second side 604B.

As shown, second side 604B may display a playlist 606 that the sharing device owner wishes to share, play commands 607, and trading card commands 612. As shown the playlist 606 may include a rating of multimedia content items, a listing of or links to multimedia content items within playlist 606, or the like. In one embodiment, additional profile information may also be provided, including, but not limited to an artist's name, photograph, avatar, or the like. In one embodiment, the mobile device user may select to click on the rating information within playlist 606 to modify it.

Second side 604B may also include side tabs 609 to enable ready access to other sides of the trading card. Thus, as illustrated tabs 609 may enable viewing of other profile information from the sharing device owner based on categories, including a profile (as might be illustrated in first side 604A), videos, songs, ringtones, or the like. It should be noted that the invention is not constrained to these categories, and virtually any category may be employed to partition and manage multimedia content and information within a trading card.

Play commands 607 enables the mobile device user to pause, play, stop, rewind, modify a volume, or the like, for a selected multimedia content item. Selection of the multimedia content item within playlist 606 may be performed, in one embodiment, by double clicking on the listed item, clicking on the item and selecting an open command with trading card commands 612, or the like. In one embodiment, play commands 607 may include a share command 608 that enables the mobile device user to share the playlist, a modified version of the playlist, or even to share the mobile device user's own playlist (depending, in one embodiment, upon what playlist is illustrated within playlist 606).

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A processor readable medium that includes data and instructions, wherein the execution of the instructions on a server device provides for managing content over a network by enabling actions, comprising:
establishing on the server device a profile that is associated with a first client device, wherein the profile includes information to be shared with another client device;
receiving from the first mobile device an indication that the profile is to be shared with the other client device;
updating the profile to include information about the other client device;
providing by the server device access to the profile information by the other client device such that the other client device is enabled to view the profile information within at least a trading card format; and
enabling the first client device to modify at least some of the profile information such that the other client device is enabled to view the updated profile information.

2. The processor readable medium of claim 1, wherein the profile information is displayable at the other client device in an n-sided trading card format.

3. The processor readable medium of claim 1, wherein the profile information includes a link to other information.

4. The processor readable medium of claim 1, wherein the modified information is reflected within a display at the other client device, in a different format.

5. The processor readable medium of claim 1, wherein the other client device receives a message indicating that the profile information has been updated.

6. The processor readable medium of claim 1, wherein at least one of the first client device or the other client device receives a reward for sharing of the profile information.

7. A method for managing a mobile device to manage sharing of content over a network, comprising:
receiving profile information from a first mobile device, wherein the profile information includes sharable social networking content;
communicating with a server device a second mobile device's identifier for which the profile information may be shared;
associating by the server device the profile information with the second mobile device's identifier;
receiving by the server device a request from the second mobile device to view the profile information; and
enabling viewing of the profile information by the second mobile device, wherein the profile information is viewable at the server device using in at least a multi-sided trading card format.

8. The method of claim 7, further comprising:
providing to the server device a code by both the first mobile device and the second mobile device, wherein the server device employs, in part, the code to determine whether to associate the second mobile device's identifier with the profile information.

9. The method of claim 7, further comprising:
modifying at least some of the profile information by the first mobile device; and
providing a message by the server device to the second mobile device indicating that the profile information has been modified.

10. The method of claim 7, wherein the trading card further comprises:
a first side of the multi-sided trading card includes at least one graphic or text information about a user of the first mobile device; and
at least one other side of the multi-sided trading card includes the playlist that enables the recipient to select or rate at least one item identified within the playlist.

11. The method of claim 7, wherein at least one of a user of the first mobile device or a user of the second mobile device receives a financial reward for sharing access to the profile information.

12. The method of claim 7, wherein the first mobile user provides a constraint on a number of times in which the profile information can be shared by one or more other users.

13. A modulated data signal configured to include program instructions for performing the method of claim 7.

14. A network device to manage a mobile sharing of content, comprising:
a transceiver to send and receive data over a network; and
a processor that is operative to perform actions, comprising:
receiving social networking information associated with a user of a first mobile device;
creating a profile at the network device based on the social networking information and associating the profile to the first mobile device;
receiving information, in part, from the first mobile device indicating that the profile information is viewable by a second mobile device;
enabling the second mobile device to view the profile information within a multi-sided trading card format; and
providing a reward to the user of the first mobile device based on enabling the second mobile device to view the profile information.

15. The network device of claim 14, wherein the first mobile device and the second mobile device are configured to communicate information to enable the second mobile device to view the profile information, wherein the communication is through a wireless personal area network (WPAN), including at least one of Bluetooth™, Ultra-wide band communication (UWB), or an Infrared Data Association (IrDA) interface.

16. The network device of claim 14, wherein receiving information, in part, from the first mobile device further comprises receiving at least one of a code, or a device identifier associated with the second mobile device.

17. The network device of claim 14, wherein the processor that is operative to perform actions, comprising:
if an account does not exist for the first mobile device on the network device, creating an account using a device identifier of the first mobile device, and associating the profile with the account;
if an account does not if an account does not exist for the second mobile device on the network device, creating an account using a device identifier of the second mobile device; and
wherein receiving information indicating that the profile information is viewable by the second mobile device further comprises:
receiving the device identifier of the second mobile device; and
modifying account information for the first mobile device to associate the device identifier of the second mobile device with the sharable profile.

18. A system for sharing of information over a network, comprising:
a first client device that is configured and arranged to perform actions, including:
providing information about a user of the first client device to a server device, wherein the information is useable to create a profile;
communicating information to the server device indicating that the profile is sharable with another client device, wherein the other client device is constrained from modifying the profile information; and
the server device that is configured to perform actions, including:
creating an account for the first client device, and the profile;
based on the information that the profile is sharable, determining a device identifier for the other client device, and associating the device identifier of the other client device with the profile to enable the other client device to view the profile;
receiving a request from the other client device to view the profile; and
providing a reward to at least one of the first client device or the other client device for sharing of the profile.

19. The system of claim 18, wherein the profile is viewable by the other client device within a multi-sided trading card format.

20. The system of claim 18, wherein communicating information to the server device indicating that the profile is sharable further comprises:
receiving a code from both the first client device and the other client device within a defined time period; and
if the codes match, enabling the other client device to view the profile.
